(19) United States
(12) Patent Application Publication
(10) Pub. No.: US 2020/0198918 A1
(43) Pub. Date: Jun. 25, 2020

(54) ADHERING JIG AND ADHERING METHOD

(71) Applicant: 3M INNOVATIVE PROPERTIES COMPANY, St. Paul, MN (US)

(72) Inventors: Takayoshi Fujino, Sagamihara (JP); Masayuki Kubota, Hadano (JP); Yasuyuki Daigo, Machida (JP); Akihide Okamoto, Gotemba (JP); Mina Tanaka, Ebina (JP); Hiroyuki Matsuoka, Yokohama (JP)

(21) Appl. No.: 16/613,204

(22) PCT Filed: May 25, 2018
(86) PCT No.: PCT/IB2018/053753

§ 371 Date: Nov. 13, 2019

(30) Foreign Application Priority Data
May 31, 2017 (JP) 2017-108234

(51) Int. Cl. B65H 37/00; B29C 63/02

(52) U.S. Cl. CPC B65H 37/005; B29C 63/0073; B29C 63/024

(57) ABSTRACT

An adhering jig and an adhering method that can improve workability when adhering a film to an adherent. The adhering jig includes a film retaining portion (3), a pressing portion (4), and a guide member (2). The film retaining portion includes at least a first retaining portion (11) and a second retaining portion (12) that are separated from each other, and retains the film (51) by the first retaining portion and the second retaining portion. The pressing member presses the film retained by the retaining portion to a first side in a first direction. The guide member guides a movement of the pressing member between the first retaining portion and the second retaining portion of the film retaining portion, in a second direction that intersects the first direction.

### TECHNICAL FIELD

The present invention relates to an adhering jig and an adhering method for a film.

### BACKGROUND ART

There have been known adhering jigs for adhering a film to an adherent, including the adhering jig described in JP 2001-39365 A. This adhering jig is provided to an upper end side of a frame of an automobile, extending in an up-down direction, and is positioned with an upper end side of the film retained therein. Subsequently, a worker adheres the film to the frame by moving the film in the up-down direction while pressing the film with a pressing member such as a squeegee.

### SUMMARY OF THE INVENTION

Nevertheless, when the film is adhered using an adhering jig such as described above, the film may not adhere easily depending on the shape of the adherent, causing a shock line or the like to occur, affecting design characteristics after film adherence. Accordingly, an adhering jig and an adhering method that can improve workability when adhering a film to an adherent have been in demand.

An adhering jig according to an aspect of the present invention is an adhering jig for adhering a film to an adherent, including a film retaining portion that is provided with at least a first retaining portion and a second retaining portion that are separated from each other, and retains the film by the first retaining portion and the second retaining portion, a pressing member that presses the film retained by the retaining portion to a first side in a first direction, and a guide member that guides a movement of the pressing member between the first retaining portion and the second retaining portion of the film retaining portion, in a second direction that intersects the first direction.

According to such an aspect, the film retaining portion can retain the film by the first retaining portion and the second retaining portion separated from each other. Thus, positioned between the adherent and the film, the film retaining portion is capable of retaining the film. The guide member is capable of guiding the movement of the pressing member between the first retaining portion and the second retaining portion of the film retaining portion, in the second direction that intersects the first direction. Thus, the pressing member presses the film retained by the first retaining portion and second retaining portion in a positioned state onto the adherent and, in this state, moves while guided by the guide member, making it possible to accurately adhere the film to the adherent in conformance with the guide member. With the simple operation of merely retaining the film by the film retaining portion and moving the pressing member in conformance with the guide member, the film can be favorably adhered. With the above, it is possible to improve workability when adhering a film to an adherent.

In the adhering jig according to another aspect, the pressing member may include an elastic member capable of expanding and contracting in the first direction.

In the adhering jig according to another aspect, the film retaining portion may further include a pivoting portion that causes at least one of the first retaining portion and the second retaining portion to pivot.

The adhering jig according to another aspect may further include a first attaching portion that attaches the guide member to the adherent. In such a configuration, the first attaching portion is connected to the guide member via a first pivoting support portion that pivotably supports one end side of the guide member in the second direction.

The adhering jig according to another aspect may further include a second attaching portion that attaches the guide member to the adherent. In such a configuration, the guide member extends in the second direction and curves so as to form a projection toward a second side in the first direction.

In the adhering jig according to another aspect, the film retaining portion may retain the film so that the film forms a tangent with respect to any position on a curved surface of the adherent between the first retaining portion and the second retaining portion, as viewed from a third direction that intersects the first direction and the second direction.

In the adhering jig according to another aspect, the guide member attached to the adherent via the second attaching portion forms a non-parallel positional relationship with the film retained by the film retaining portion, as viewed from the third direction that intersects the first direction and the second direction.

In the adhering jig according to another aspect, the second attaching portion may be connected to the guide member via a second pivoting support portion that pivotably supports one end side of the guide member in the second direction.

An adhering method according to an aspect of the present invention may be an adhering method for adhering a film to an adherent using the adhering jig described above. The method includes a film retaining step of retaining the film by the film retaining portion, an attaching step of attaching the guide member to the adherent via the first attaching portion, and an adhering step of adhering the film to the adherent by pressing the film retained by the film retaining portion onto the adherent using a pressing member, and moving the pressing member in conformance with the guide member attached to the adherent. In the adhering step, the film is adhered by the pressing member while the guide member is pivoted by the first pivoting support portion.

An adhering method according to another aspect of the present invention may be an adhering method for adhering a film to an adherent using the adhering jig described above, the method including a film retaining step of retaining the film by the film retaining portion, an attaching step of attaching the guide member to the adherent via the second attaching portion, and an adhering step of adhering the film to the adherent by pressing the film retained by the film retaining portion onto the adherent using the pressing member, and moving the pressing member in conformance with the guide member attached to the adherent. In the attaching step, the guide member is attached to the adherent so as to curve in conformance with a curved surface of the adherent.

### Effect of the Invention

According to the present invention, it is possible to provide an adhering jig and an adhering method that can improve workability when adhering a film to an adherent.

### BRIEF DESCRIPTION OF THE DRAWINGS

FIG. 1 is a perspective view illustrating an adhering jig according to a first embodiment of the present invention.

FIG. 2 is a perspective view illustrating the adhering jig illustrated in FIG. 1.

FIG. 3 is a schematic side view illustrating the adhering jig illustrated in FIG. 1.

FIG. 4 is an enlarged perspective view of the adhering jig illustrated in FIG. 1.

FIG. 5 is an enlarged perspective view of the adhering jig illustrated in FIG. 1.

FIG. 6 is a diagram illustrating an example of an adherent.

FIG. 7 is a schematic side view for explaining an adhering method that uses the adhering jig illustrated in FIG. 1.

FIG. 8 is a schematic side view for explaining the adhering method that uses the adhering jig illustrated in FIG. 1.

FIG. 9 is a schematic side view for explaining the adhering method that uses the adhering jig illustrated in FIG. 1.

FIG. 10 is a schematic side view for explaining the adhering method that uses the adhering jig illustrated in FIG. 1.

FIG. 11 is a schematic side view for explaining the adhering method that uses the adhering jig illustrated in FIG. 1.

FIG. 12 is a schematic side view for explaining the adhering method that uses the adhering jig illustrated in FIG. 1.

FIG. 13 is a perspective view illustrating an adhering jig according to a second embodiment of the present invention.

FIG. 14 is a schematic side view illustrating the adhering jig illustrated in FIG. 13.

FIG. 15 is a schematic side view for explaining the adhering method that uses the adhering jig illustrated in FIG. 13.

FIG. 16 is a schematic side view for explaining the adhering method that uses the adhering jig illustrated in FIG. 13.

FIG. 17 is a schematic side view for explaining the adhering method that uses the adhering jig illustrated in FIG. 13.

FIG. 18 is a schematic side view for explaining the adhering method that uses the adhering jig illustrated in FIG. 13.

FIG. 19 is a schematic side view for explaining the adhering method that uses the adhering jig illustrated in FIG. 13.

FIG. 20 is a schematic side view for explaining the adhering method that uses the adhering jig illustrated in FIG. 13.

### DESCRIPTION OF THE PREFERRED EMBODIMENTS

Detailed descriptions of the embodiments according to the present invention are given below with reference to the attached drawings. Note that, in the following descriptions, the same reference symbols have been assigned to elements that are the same or equivalent, and that redundant descriptions thereof have been omitted.

### First Embodiment

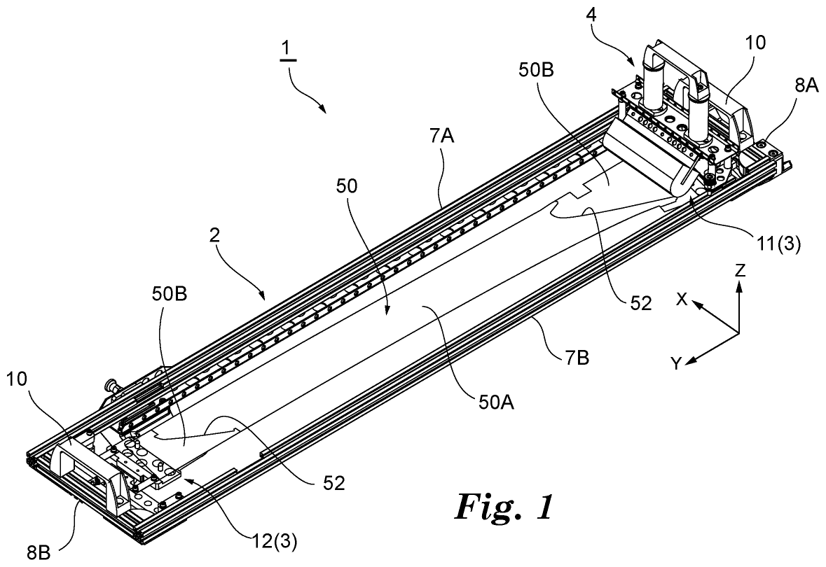

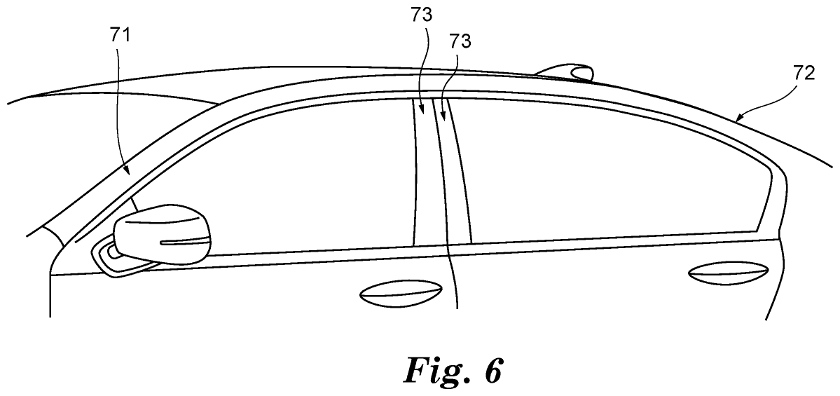

An adhering jig 1 according to an embodiment of the present invention illustrated in FIG. 1 is a jig for adhering a film 50 to an adherent. The adhering jig 1 is attached to the adherent with the film 50 retained therein. In this state, a worker can adhere the film 50 to the adherent by performing adherence work while using the adhering jig 1. The film 50 used in the present embodiment is a decorative film that includes an adhesive portion (a portion with adhesive (pressure-sensitive adhesive)) applied on a back surface thereof, and is colored, provided with a pattern, or the like. The decorative film is used as a coating substitution film in applications where film adherence is performed in place of coating application. The adherent used may be a variety of target objects as long as the object requires formation of a design surface. Further, when the adherent used has a long, curved shape, the advantages of the adhering jig 1 according to the present embodiment are particularly suitably obtained. For example, the adherent may be a door frame part for a vehicle or a window sash part for a vehicle. As illustrated in FIG. 6, examples of the door frame part for a vehicle include an A pillar (front-side pillar) 71, a C pillar (rear-side pillar) 72, and the like of an automobile, and examples of the window sash part for a vehicle include a B pillar (center pillar in a vehicle front-back direction) 73, and the like. Note that the adhering jig 1 of the present embodiment is particularly effective for an adherent for which film adherence work is difficult to perform, such as an adherent having a large curvature and a twisting curvature. Thus, with the A pillar 71 used as the adherent, the advantages of the adhering jig 1 are more significant. For example, for the A pillar 71, the required length of the film 50 is about 1.5 times that of the B pillar 73. As a result, a shift in an adherence angle at the start of adherence has a significant impact, and thus this shift needs to be small. Further, a cross-sectional shape of the design surface of the A pillar 71 is extremely complex compared to that of the B pillar 73, making the film 50 difficult to adhere. For example, the cross-sectional shape of the design surface of the B pillar 73 can be regarded as substantially formed by a single surface, with both end portions folded back from the design surface to a back side bending at acute angles, resulting in clear boundaries between the design surface and folded back portions. In comparison, the cross-sectional shape of the design surface of the A pillar 71 significantly balloons outward, and thus is regarded as being formed by substantially two surfaces. Further, both end portions folded back from the design surface to the back side gently curve, resulting in a shape having hard to identify boundaries between the design surface and the folded back portions. Thus, when the film 50 is adhered to the A pillar 71, adherence work needs to be performed on the design surface having a complex cross-sectional shape. Further, the A pillar 71 has significant twisting compared to the B pillar 73. For example, the cross-sectional shape of the B pillar 73 does not significantly change at the adherence start location or the adherence end location of the film 50. On the other hand, the cross-sectional shape of the adherence start location and the cross-sectional shape of the adherence end location of the A pillar 71 differ due to the effects of the twisting of the A pillar 71. Thus, when the film 50 is adhered to the A pillar 71, the way the film 50 is pressed needs to be changed at the adherence start location and the adherence end location.

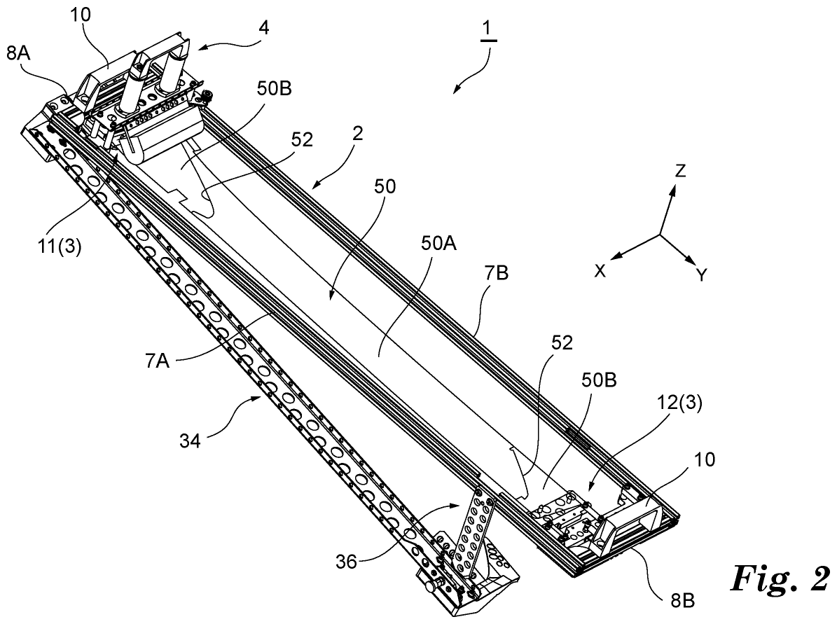

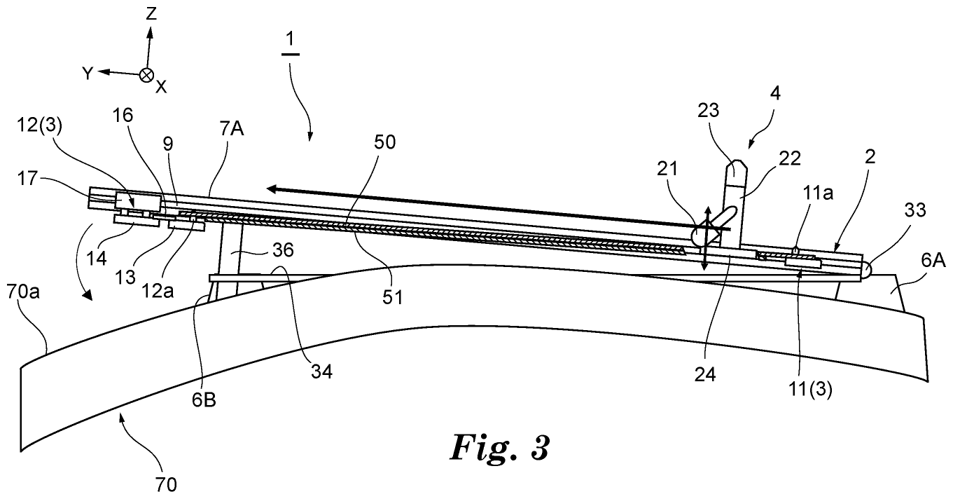

The detailed configuration of the adhering jig 1 according to the first embodiment will now be described with reference to FIGS. 1 to 3. As illustrated in FIGS. 1 to 3, the adhering jig 1 includes a guide member 2, a film retaining portion 3, a pressing member 4, and attaching portions 6A, 6B. The adhering jig 1 according to the present embodiment includes a mechanism that opens and closes the guide member 2 with respect to the attaching portions 6A, 6B connected to the adherent. The user adheres the film 50 to the adherent while opening and closing the guide member 2 of the adhering jig 1. Note that the descriptions below are made with an XYZ coordinate system set with respect to the guide member 2. The Z-axis direction is the direction (first direction) in which the pressing member 4 presses the film 50 retained by the film retaining portion 3. The Y-axis direction is the direction (second direction) that intersects (here, is orthogonal to) the Z-axis direction, and in which the guide member 2 guides the movement of the pressing member 4. The X-axis direction is the direction (third direction) that intersects (here, is orthogonal to) the Z-axis direction and the Y-axis direction. Further, the direction in which the pressing member 4 presses the film 50 is the negative side in the Z-axis direction. The direction in which the pressing member 4 advances when the film 50 is adhered is the positive side in the Y-axis direction. A first side in the X-axis direction is the positive side in the X-axis direction. Note that the XYZ coordinate system is a relative coordinate system set with respect to the guide member 2, and moves in accordance with the opening and closing movement of the guide member 2. Note that FIG. 1 illustrates the guide member 2 in a closed state. FIG. 2 illustrates the guide member 2 in an open state. FIG. 3 illustrates the adhering jig 1 attached to an adherent 70, with the guide member 2 in an open state. In FIG. 3, to explain the structure inside the guide member 2, a long side portion 7B and short side portions 8A, 8B described later of the guide member 2 are omitted.

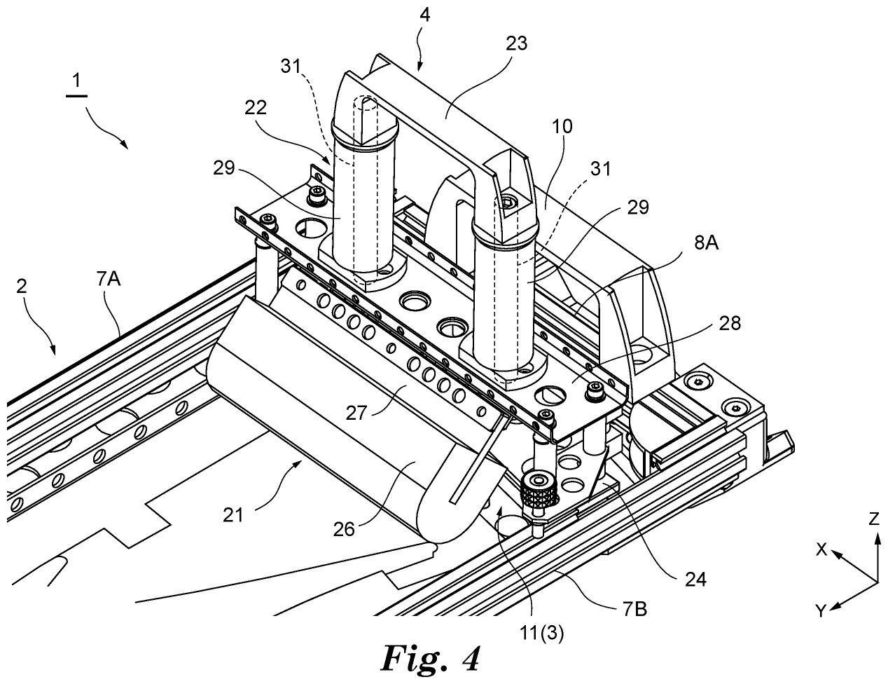

The guide member 2 is a member for guiding the movement of the pressing member 4 in the Y-axis direction between a first retaining portion 11 and a second retaining portion 12 described later. The guide member 2 is a member having a long, rectangular frame shape in the Y-axis direction. The guide member 2 includes long side portions 7A, 7B that are separated from each other in the X-axis direction and extend parallel in the Y-axis direction. The long side portion 7A is disposed on the positive side in the X-axis direction, and the long side portion 7B is disposed on the negative side in the X-axis direction. In the present embodiment, the long side portions 7A, 7B each extend in a straight line in the Y-axis direction. A guide groove 9 for guiding the pressing member 4 in the Y-axis direction is formed on a side surface on an inner peripheral side of each of the long side portions 7A, 7B (refer to FIGS. 3 and 4). The guide member 2 further includes short side portions 8A, 8B that extend parallel in the X-axis direction in both end portions of the long side portions 7A, 7B in the Y-axis direction. The short side portion 8A is disposed on the negative side in the Y-axis direction, and the short side portion 8B is disposed on the positive side in the Y-axis direction. Handle portions 10 for the worker to grasp when attaching the adhering jig 1 and the like are provided on the short side portions 8A, 8B. Note that the shape of the guide member 2 is not particularly limited as long as the shape allows guidance of the pressing member 4, and the handle portions 10 may be omitted.

The film retaining portion 3 includes the first retaining portion 11 and the second retaining portion 12 separated from each other, and retains the film 50 by the first retaining portion 11 and the second retaining portion 12. The first retaining portion 11 and the second retaining portion 12 are provided so as to face each other in the Y-axis direction and be separated from each other. The first retaining portion 11 retains an end portion on the negative side in the Y-axis direction of the film 50, which extends lengthwise in the Y-axis direction, in a region on the inner peripheral side of the guide member 2. The second retaining portion 12 retains an end portion on the positive side in the Y-axis direction of the film 50, which extends lengthwise in the Y-axis direction, in the region on the inner peripheral side of the guide member 2.

As illustrated in FIG. 3, the first retaining portion 11 is provided on the short side portion 8A side on the negative side in the Y-axis direction of the guide member 2. The first retaining portion 11 is fixed to the short side portion 8A and formed in the region on the inner peripheral side of the guide member 2 by a plate-like member extending toward the positive side in the Y-axis direction. The first retaining portion 11 includes on the end portion on the positive side in the Y-axis direction a retaining pin 11a that protrudes toward the positive side in the Z-axis direction. The retaining pin 11a is inserted through a through-hole formed in the end portion of the film 50, thereby retaining the end portion of the film 50.

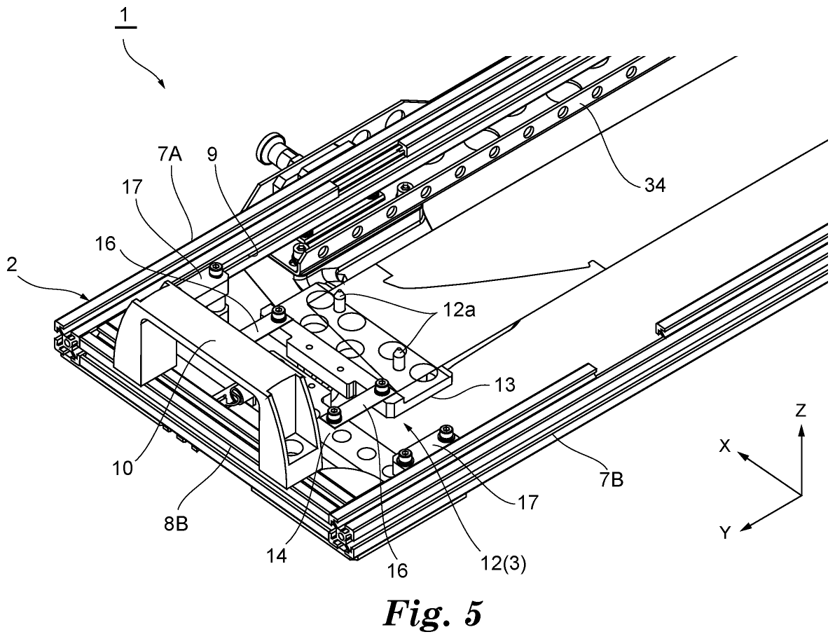

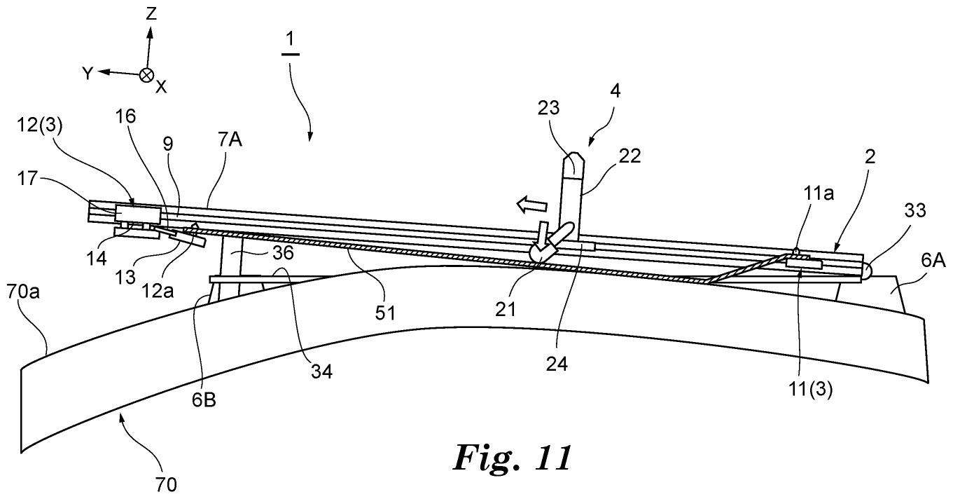

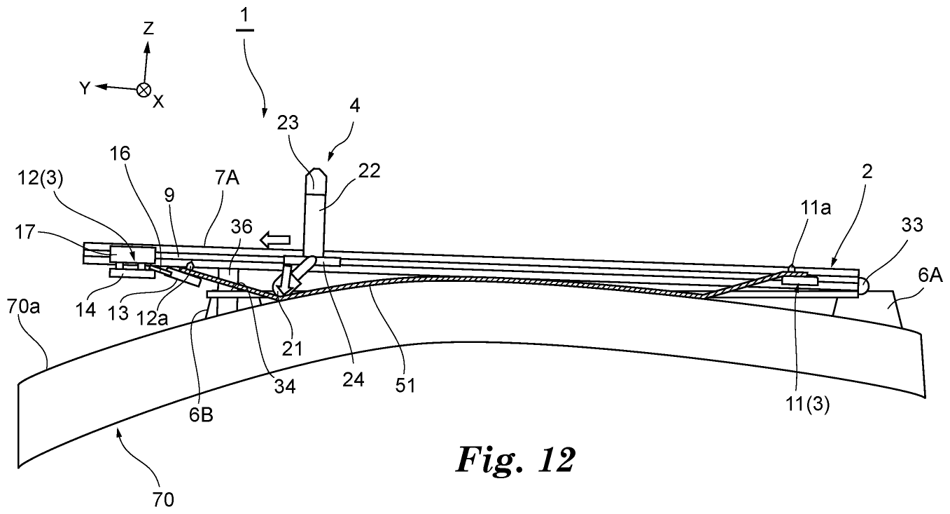

As illustrated in FIGS. 3 and 5, the second retaining portion 12 is provided on the short side portion 8B side on the positive side in the Y-axis direction of the guide member 2. Here, the film retaining portion 3 includes a pivoting portion 13 that causes the second retaining portion 12 to pivot. Further, the film retaining portion 3 includes slide portions 17 that cause the second retaining portion 12 to slide in the Y-axis direction. Specifically, the second retaining portion 12 includes the slide portions 17 slidably attached to the guide member 2, a base portion 14 fixed to the slide portions 17, and the pivoting portion 13 pivotably attached to the base portion 14. The slide portions 17 are respectively attached to the guide grooves 9 of the long side portions 7A, 7B of the guide member 2, and moveable in the Y-axis direction while guided in the guide grooves 9. Further, the slide portions 17, when positioned in the Y-axis direction, are fixable in the guide member 2. The base portion 14 is fixed to the slide portions 17 and formed by a plate-like member extending toward the negative side in the Y-axis direction in the region on the inner peripheral side of the guide member 2. The pivoting portion 13 is a plate-like member disposed on the negative side in the Y-axis direction with respect to the base portion 14 in the region on the inner peripheral side of the guide member 2. The pivoting portion 13 is connected to the base portion 14 via connecting members 16 having flexibility. The pivoting portion 13 includes retaining pins 12a on the end portion on the negative side in the Y-axis direction, each protruding toward the positive side in the Z-axis direction. The retaining pins 12a are inserted through through-holes formed in the end portion of the film 50, thereby retaining the end portion of the film 50. With such a configuration as described above, when the pressing member 4 moves near the second retaining portion 12 at the time of adhesion, the connecting member bends toward the negative side in the Z-axis direction, causing the pivoting portion 13 to pivot toward the negative side in the Z-axis direction with the film 50 retained as is (refer to FIGS. 11 and 12).

As illustrated in FIGS. 1 and 2, both end portions of the film 50 in the Y-axis direction are retained by the first retaining portion 11 and the second retaining portion 12 in the region on the inner peripheral side of the guide member 2. Further, the positions of the slide portions 17 of the second retaining portion 12 are adjusted in the Y-axis direction so that the film 50 is retained by the first retaining portion 11 and the second retaining portion 12 with tension applied. Note that the film 50 with tension applied thereto may extend in parallel or not in parallel with the guide member 2 in the Y-axis direction.

The back surface (the surface on the negative side in the Z-axis direction) side of the film 50 is covered by a liner 51 for protecting an adhesive portion on the back surface of the film 50. Further, a cut line 52 for cutting the film 50 into a shape after adherence onto the adherent 70 is formed in a region on both end sides of the film 50 in the Y-axis direction. In the film 50, a region 50A on an inner side in the Y-axis direction of the cut line 52 is a portion adhered to the adherent 70, and a region 50B on an outer side is a portion discarded after adherence is completed. A cutting groove, perforations, or the like are formed in the cut line 52, making the region 50B that is not required easily removable by the worker after adherence. Note that a surface (surface on the positive side in the Z-axis direction) side of the film 50 may be covered by a sheet. In this case, the region 50A and the region 50B of the film 50 are connected via the sheet. Further, when the film 50 is covered by the sheet, the region 50B may be removed in advance when the film 50 is retained by the first retaining portion 11 and the second retaining portion 12. In this case, the sheet portion is retained by the first retaining portion 11 and the second retaining portion 12.

As illustrated in FIG. 3, the pressing member 4 is a member that presses the film 50 retained by the film retaining portion 3 toward the negative side (the first side in the first direction) in the Z-axis direction. The pressing member 4 is movable in the Z-axis direction. That is, the pressing member 4 can be moved toward the negative side in the Z-axis direction to press the film 50 onto the adherent 70, and can be moved toward the positive side in the Z-axis direction to release the pressed state of the film 50. The pressing member 4 is movable in the Y-axis direction while guided by the guide member 2. The pressing member 4 includes a pressing portion 21 serving as a section that presses the film 50, a moving mechanism 22 that movably supports the pressing portion 21 in the Z-axis direction, a handle portion 23 that allows the worker to operate the pressing member 4, and a slide portion 24 that is slidable in conformance with the guide grooves 9 of the guide member 2.

More specifically, as illustrated in FIG. 4, the pressing portion 21 includes a main body portion 26 provided with a leading edge surface that serves as a pressing surface and forms a semicircular shape when viewed from the X-axis direction, and a connecting portion 27 that connects the main body portion 26 to the moving mechanism 22. The main body portion 26 is disposed in the region on the inner peripheral side of the guide member 2, and at least the dimension in the X-axis direction is greater than that of the film 50. The moving mechanism 22 includes a base portion 28 fixed to the slide portion 24 in a position on the positive side in the Z-axis direction, a pair of elastic members 29 attached to the base portion 28, and rod portions 31 disposed in interiors of the elastic members 29. The end portions of the pair of elastic members 29 on the positive side in the Z-axis direction are connected by the handle portion 23. Further, the elastic members 29 are inserted between the handle portion 23 and the base portion 28, and disposed in a way that permits elastic deformation. The rod portions 31 each include an upper end portion connected to the handle portion 23, and a lower end portion connected to the connecting portion 27 (extending to a back surface of the base portion 28, that is, to at least a portion on the negative side in the Z-axis direction). Further, the connecting portion 27 is connected to the pressing portion 21. According to such a configuration, when the worker presses the handle portion 23 toward the negative side in the Z-axis direction, the pressing portion 21 moves toward the negative side in the Z-axis direction via the rod portions 31. As a result, the pressing portion 21 can press the film 50 onto the adherent 70. Furthermore, the worker applies force toward the positive side in the Y-axis direction while holding the handle portion 23, causing the pressing member 4 in its entirety to move toward the positive side in the Y-axis direction in conformance with the guide grooves 9 via the slide portion 24. As a result, the pressing member 4 moves toward the positive side in the Y-axis direction while pressing the film 50, making it possible to apply a pressing force across an entire range of the film 50. Further, in this state, the elastic members 29 are compressed by the handle portion 23. Thus, when the worker releases the handle portion 23, the elastic members 29 push the handle portion 23 upward toward the positive side in the Z-axis direction. As a result, the pressing portion 21 is pushed upward toward the positive side in the Z-axis direction via the handle portion 23 and the rod portions 31.

As illustrated in FIG. 3, the attaching portions 6A, 6B are members for attaching the guide member 2 to the adherent 70. As illustrated in FIGS. 2 and 3, the attaching portion 6A is disposed on the negative side in the Y-axis direction with respect to the guide member 2. The attaching portion 6B is disposed on the positive side in the Y-axis direction with respect to the guide member 2. The attaching portion 6A is connected to the guide member 2 via a pivoting support portion (first pivoting support portion) 33 that pivotably supports the negative side (one end side in the second direction) of the guide member 2 in the Y-axis direction. The pivoting support portion 33 is formed by a hinge mechanism that connects the attaching portion 6A and the guide member 2. The attaching portion 6B and the guide member 2 are not fixed. Rather, the end portion of the guide member 2 on the positive side in the Y-axis direction can be freely separated from and brought close to the attaching portion 6B. A connecting member 34 having a rod shape and connecting the attaching portion 6A and the attaching portion 6B extends across the attaching portion 6A and the attaching portion 6B. The connecting member 34 is disposed on the positive side in the X-axis direction, and extends in the Y-axis direction. The connecting member 34 is disposed in a position that does not hinder the pressing of the film 50 by the pressing member 4. Further, a lock member 36 for locking the opening and closing position of the guide member 2 is provided near the end portion of the long side portion 7A of the guide member 2 on the positive side in the Y-axis direction. The lock member 36 extends from the long side portion 7A toward the negative side in the Z-axis direction, and is inserted into a hole formed in the attaching portion 6B. The worker, while working, sets the guide member 2 to an open state and, when a posture of the guide member 2 is maintained in the opening and closing position, fixes the lock member 36 to the attaching portion 6B.

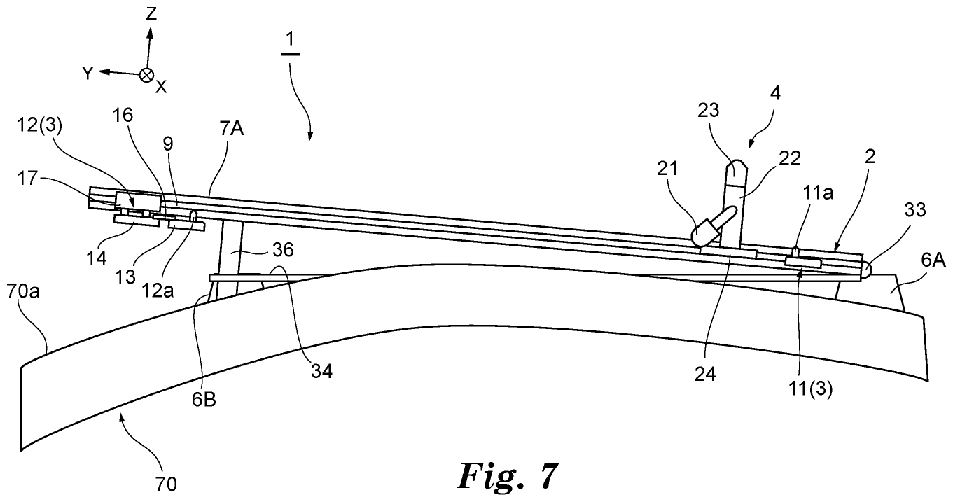

Next, the steps of an adhering method of the film 50 using the adhering jig 1 will be described with reference to FIGS. 7 to 12. First, as illustrated in FIG. 7, an attaching step of attaching the guide member 2 to the adherent 70 via the attaching portions 6A, 6B is executed. In this state, the guide member 2 is open with respect to the attaching portions 6A, 6B. At this time, the attaching portions 6A, 6B and the adherent 70 are attached to the adherent 70 while being positioned between the guide member 2 and the adherent 70.

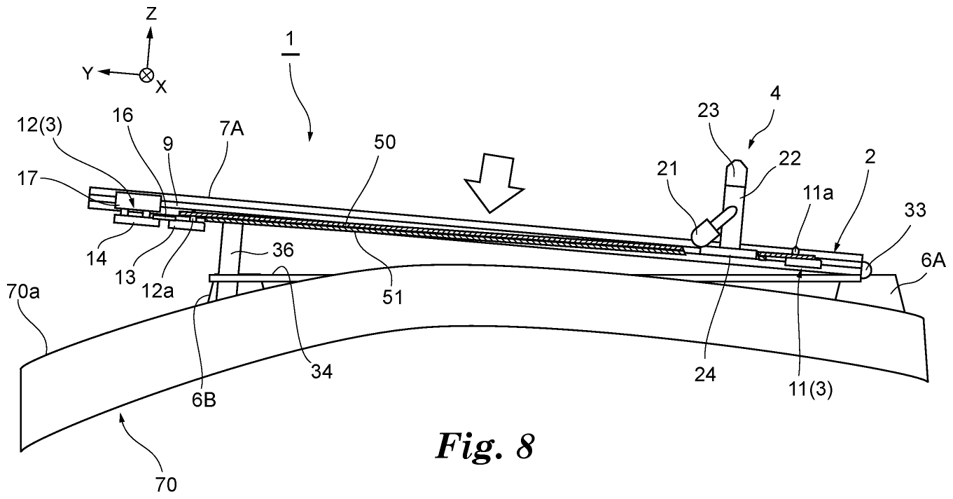

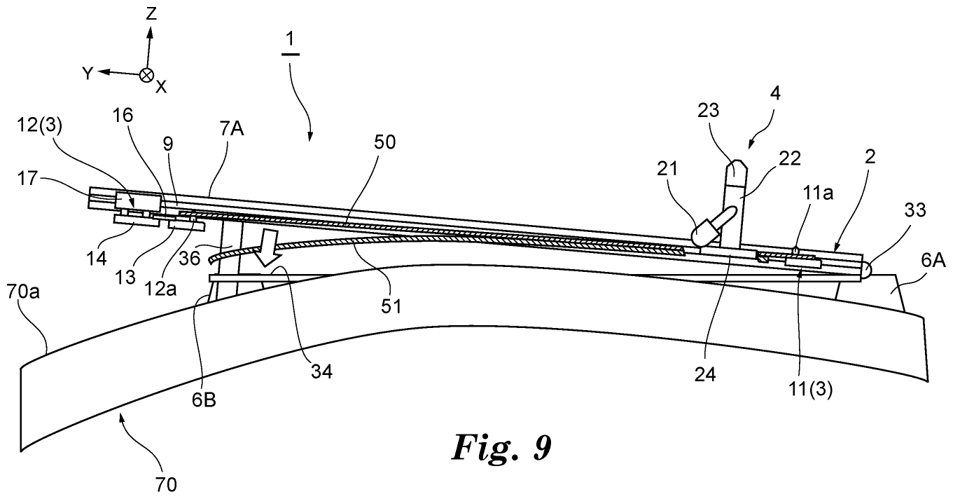

Next, as illustrated in FIG. 8, a film retaining step of retaining the film 50 by the film retaining portion 3 is executed. In this step, both ends of the film 50 are respectively retained by the first retaining portion 11 and the second retaining portion 12. The film 50 is positioned in the Y-axis direction of the second retaining portion 12 while retained by the film retaining portion 3, thereby stretching the slack of the film 50 and retaining the film 50 with tension applied. As a result, the film 50 can be positioned with respect to the adherent 70. After this step, as illustrated in FIG. 9, the step of removing the liner 51 from the film 50 is executed.

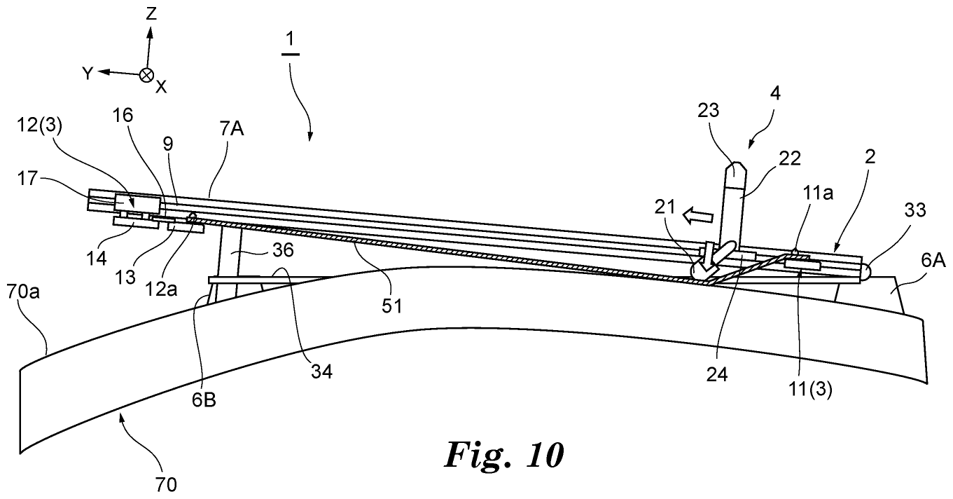

Next, as illustrated in FIGS. 10 to 12, the adhering step of adhering the film 50 to the adherent 70 is executed by pressing the film 50 retained by the film retaining portion 3 to the adherent 70 using the pressing member 4, and moving the pressing member 4 in conformance with the guide member 2 attached to the adherent 70. In this step, the pressing member 4 moves toward the positive side in the Y-axis direction while pressing the film 50 onto the adherent 70, between the first retaining portion 11 and the second retaining portion 12. Further, in this step, the guide member 2 is closed while pivoted about the pivoting support portion 33 as the pressing member 4 advances toward the positive side in the Y-axis direction. As a result, the guide member 2 is closed in accordance with the movement of the pressing member 4, even when the adherent 70 has a curved shape, making it possible for the guide member 2 to come close to the adherent 70. Thus, the pressing member 4 can be disposed in a position that reaches the adherent 70. When the adhering step is completed, the film 50 is cut at the cut line 57, and the adhering jig 1 is removed from the adherent 70. With the above, the adhering method of the film is complete.

Next, the action and advantages of the adhering jig 1 and the adhering method according to the present embodiment will be described.

The film retaining portion 3 can retain the film 50 by the first retaining portion 11 and the second retaining portion 12 separated from each other. Thus, positioned between the adherent 70 and the film 50, the film retaining portion 3 is capable of retaining the film 50. The guide member 2 is capable of guiding the movement of the pressing member 4 in the Y-axis direction between the first retaining portion 11 and the second retaining portion 12 of the film retaining portion 3. Thus, the pressing member 4 presses the film 50 retained by the first retaining portion 11 and second retaining portion 12 in the positioned state onto the adherent 70 and, in this state, moves while guided by the guide member 2, making it possible to accurately adhere the film 50 to the adherent 70 in conformance with the guide member 2. With the simple operation of merely retaining the film 50 by the film retaining portion 3 and moving the pressing member 4 in conformance with the guide member 2, the film 50 can be favorably adhered. With the above, it is possible to improve workability when adhering the film 50 to the adherent 70.

In the adhering jig 1, the pressing member 4 may include the elastic members 29 capable of expanding and contracting in the X-axis direction. As a result, the pressing member 4 can press the film 50 toward the adherent 70 from a position in which the pressing member 4 is slidably attached to the guide member 2.

In the adhering jig 1, the film retaining portion 3 may include the pivoting portion 13 that causes the second retaining portion 12 to pivot. As a result, the second retaining portion 12 pivots by the pivoting portion 13 once the pressing member 4 moves near the second retaining portion 12, thereby allowing an angle of the film 50 to follow the movement of the pressing member 4.

The adhering jig 1 may further include the attaching portions 6A, 6B that attach the guide member 2 to the adherent 70. The attaching portion 6A may be connected to the guide member 2 via the pivoting support portion 33 that pivotably supports the end portion side of the guide member 2 on the negative side in the Y-axis direction. For example, when a configuration in which the guide member 2 cannot pivot with respect to the attaching portion 6A is considered, the guide member 2 significantly separates from a curved surface 70a of the adherent 70 in a region near the end portion on the positive side in the Y-axis direction when the adherent 70 significantly curves. In this case, the pressing member 4 does not reach the adherent 70, resulting in the possibility that film 50 cannot be adhered (refer to the gap between the guide member 2 and the adherent 70 near the end portion on the positive side in the Y-axis direction in FIG. 10, for example). In response, the guide member 2 is connected to the guide member 2 via the pivoting support portion 33, allowing the guide member 2 to close while pivoted about the pivoting support portion 33 as the pressing member 4 advances toward the positive side in the Y-axis direction. As a result, the guide member 2 is closed in accordance with the movement of the pressing member 4, even when the adherent 70 has a curved shape, making it possible for the guide member 2 to approach the adherent 70. Thus, the pressing member 4 can be disposed in a position that reaches the adherent 70. Further, according to the configuration, the guide member 2 is pivoted by the pivoting support portion 33 in accordance with the movement of the pressing member 4, even with a configuration in which the guide member 2 extends in a straight line in the Y-axis direction, thereby allowing adherence of the film 50 regardless of the shape of the adherent 70. Accordingly, even if there are a plurality of shapes of the adherent 70 differing to a certain degree, the adhering jig 1 can be used, making it possible to increase a versatility of the adhering jig 1.

The adhering method is an adhering method for adhering the film 50 to the adherent 70 using the adhering jig 1 described above. The method includes a film retaining step of retaining the film 50 by the film retaining portion 3, an attaching step of attaching the guide member 2 to the adherent 70 via the attaching portions 6A, 6B, and an adhering step of adhering the film 50 to the adherent 70 by pressing the film 50 retained by the film retaining portion 3 onto the adherent 70 using the pressing member 4 and moving the pressing member 4 in conformance with the guide member 2 attached to the adherent 70. In the adhering step, the film 50 may be adhered by the pressing member 4 while the guide member 2 is pivoted by the pivoting support portion 33.

Thus, in the adhering step, the film 50 is adhered by the pressing member 4 while the guide member 2 is pivoted by the pivoting support portion 33, thereby closing the guide member 2 in accordance with the movement of the pressing member 4, even when the adherent 70 has a curved shape, making it possible for the guide member 2 to come close to the adherent 70, in the same manner as the adhering jig 1 described above. Thus, the pressing member 4 can be disposed in a position that reaches the adherent 70.

### Second Embodiment

An adhering jig 100 according to the second embodiment mainly differs from the adhering jig 1 according to the first embodiment in that the position of the guide member 2 with respect to the adherent does not move, but rather is fixed when the film 50 is adhered.

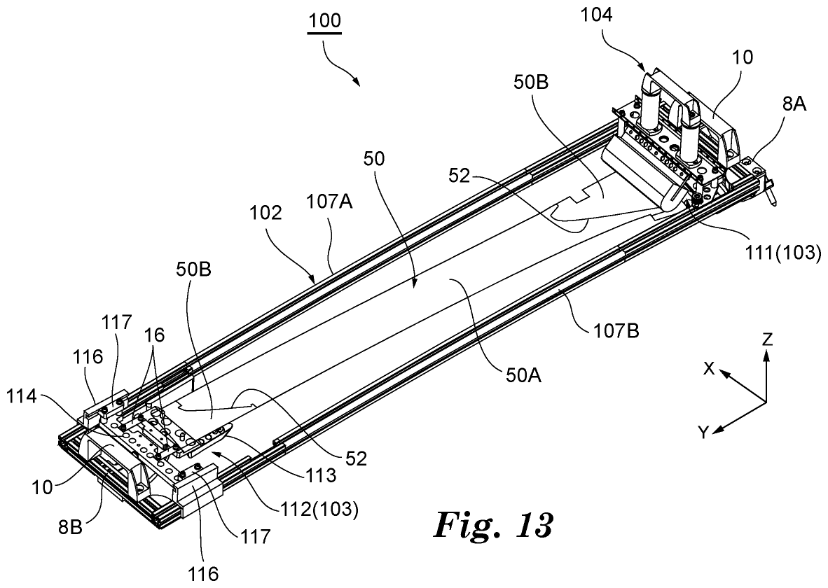

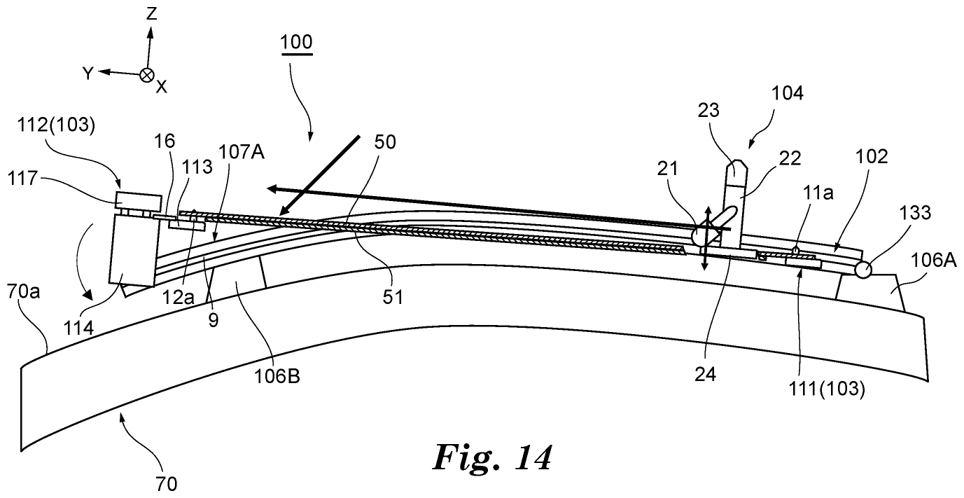

As illustrated in FIGS. 13 and 14, the adhering jig 100 includes a guide member 102, a film retaining portion 103, a pressing member 104, and attaching portions 106A, 106B.

The guide member 102 extends in the Y-axis direction and curves so as to form a protrusion toward the positive side in the Z-axis direction (second side in the first direction). That is, the guide member 102 has a curved shape that corresponds with the curved surface 70a of the adherent 70 when the adhering jig 100 is attached to the adherent 70. The long side portions 107A, 107B of the guide member 102 curve in the shapes described above. The other components are the same as those in the first embodiment.

The film retaining portion 103 includes a first retaining portion 111 and a second retaining portion 112 separated from each other, and retains the film 50 by the first retaining portion 111 and the second retaining portion 112. The first retaining portion 111 is the same as that in the first embodiment. The second retaining portion 112 includes guide portions 116 fixed to the guide member 102, slide portions 117 slidably attached to the guide member 2, a base portion 114 fixed to the slide portions 117, and a pivoting portion 113 pivotably attached to the base portion 114. The base portion 114 is movable in the Y-axis direction in conformance with the guide portions 116 via the slide portions 117, allowing positioning.

The film retaining portion 103 retains the film 50 so that the film 50 forms a tangent with respect to any position on the curved surface 70a of the adherent 70 between the first retaining portion 111 and the second retaining portion 112, as viewed from the X-axis direction. Note that “retains the film so that the film forms a tangent” indicates that the film 50 forms a tangent with respect to the curved surface 70a when moved to the adherent 70 side with the posture of the film 50 maintained as is. Further, the guide member 102 attached to the adherent 70 forms a non-parallel positional relationship with the film 50 retained by the film retaining portion 103, as viewed from the X-axis direction. According to the present embodiment, the film 50 has a positional relationship such that, as viewed from the X-axis direction, the portion supported by the second retaining portion 112 is positioned on the positive side of the guide member 2 in the Z-axis direction, and the film 50 and the guide member 2 intersect. The other components of the film retaining portion 103 are the same as those in the first embodiment.

The attaching portions 106A, 106B are members for attaching the guide member 102 to the adherent 70. At the time of adhesion, the attaching portion 106A attaches an area near the end portion of the guide member 102 on the negative side in the Y-axis direction to the adherent 70. Further, the attaching portion 106B attaches an area near the end portion of the guide member 102 on the positive side in the Y-axis direction to the adherent 70. The attaching portion 106B is connected to the guide member 2 via a pivoting support portion (second pivoting support portion) 133 that pivotably supports the negative side (one end side in the second direction) of the guide member 2 in the Y-axis direction. Further, the attaching portion 106A allows the guide member 102 to be fixed and the guide member 2 to be detached as necessary. With such a configuration, when the liner 51 is to be peeled from the film 50, the guide member 102 can be separated from the attaching portion 106A, pivoted with respect to the attaching portion 106B about the pivoting support portion 133, and lifted upward.

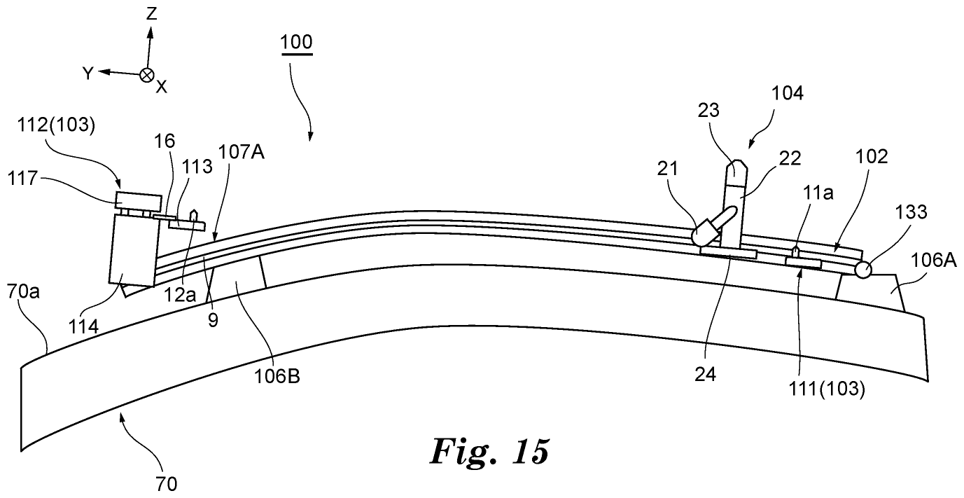

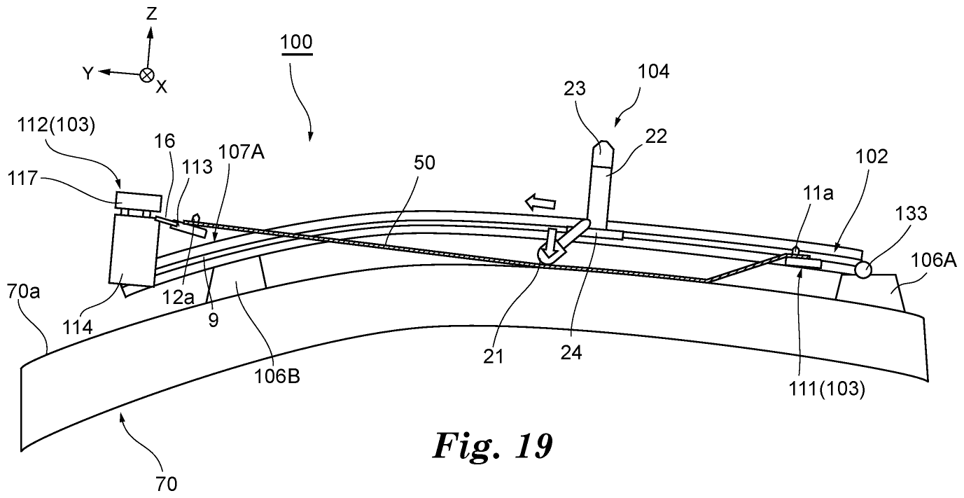

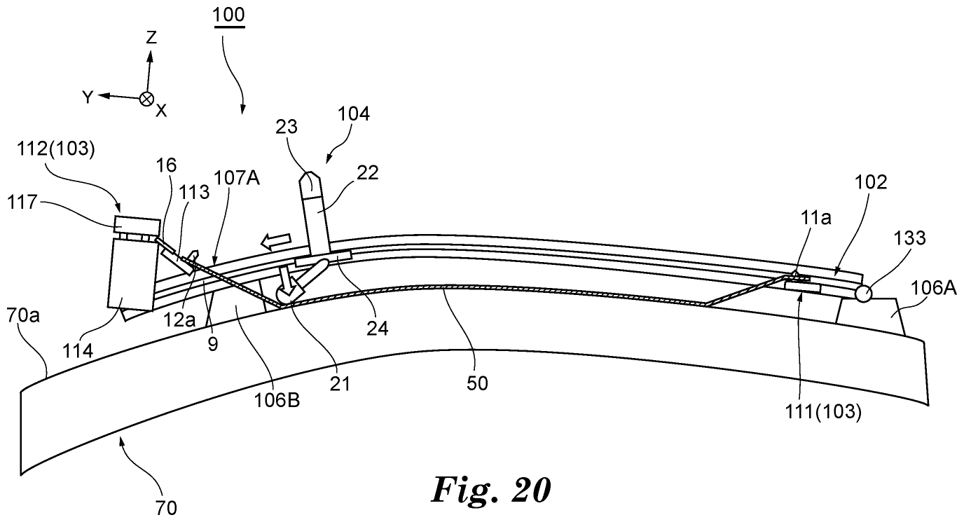

Next, the steps of the adhering method of the film 50 using the adhering jig 100 will be described with reference to FIGS. 15 to 20. First, as illustrated in FIG. 15, an attaching step of attaching the guide member 102 to the adherent 70 via the attaching portions 106A, 106B is executed. In this state, the guide member 102 is attached so as to curve in conformance with the curved surface 70a of the adherent 70. That is, the guide member 2 is attached to the attaching portions 106A, 106B so as to curve forming a protrusion toward the outer side as viewed from the adherent 70. At this time, the attaching portions 6A, 6B and the adherent 70 are attached to the adherent 70 while being positioned between the guide member 102 and the adherent 70.

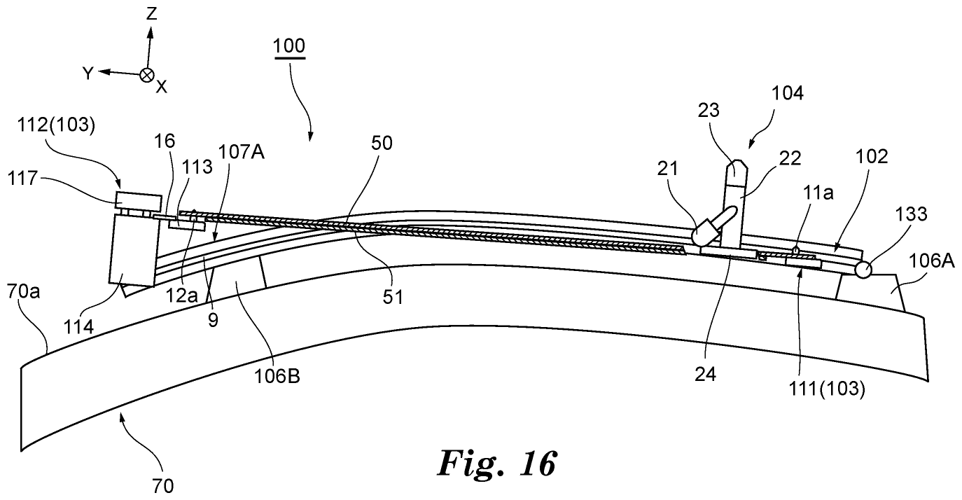

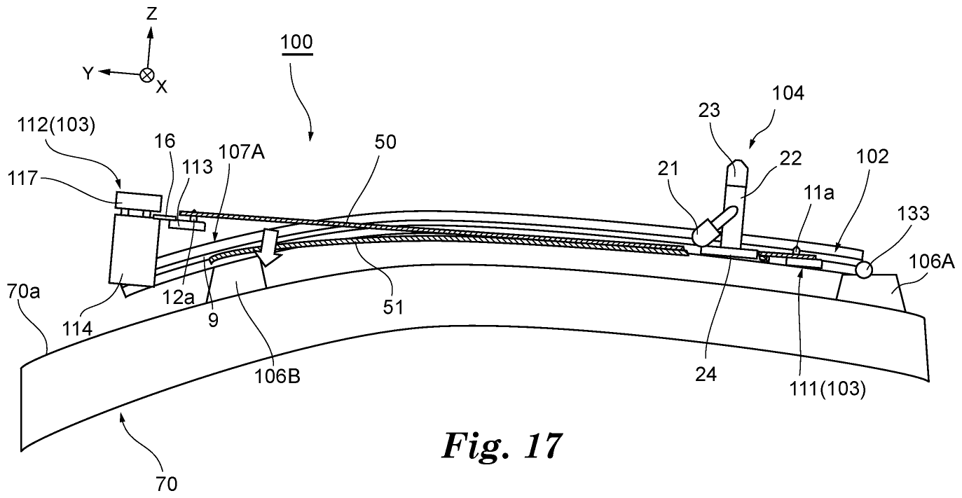

Next, as illustrated in FIG. 16, a film retaining step of retaining the film 50 using the film retaining portion 103 is executed. In this step, both ends of the film 50 are respectively retained by the first retaining portion 111 and the second retaining portion 112. The film 50 is positioned in the Y-axis direction of the second retaining portion 112 while retained by the film retaining portion 103, thereby stretching the slack of the film 50 and retaining the film 50 with tension applied. As a result, the film 50 can be positioned with respect to the adherent 70. After this step, as illustrated in FIG. 17, the step of removing the liner 51 from the film 50 is executed. Note that, when the liner 51 is peeled, the guide member 2 may be pivoted about the pivoting support portion 133 to open the guide member 102.

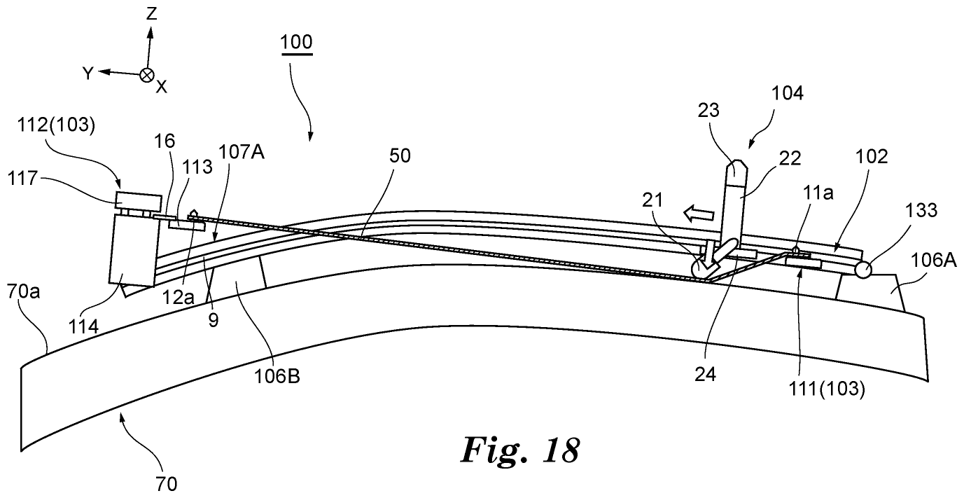

Next, as illustrated in FIGS. 18 to 20, the adhering step of adhering the film 50 to the adherent 70 is executed by pressing the film 50 retained by the film retaining portion 103 to the adherent 70 using the pressing member 104, and moving the pressing member 104 in conformance with the guide member 102 attached to the adherent 70. In this step, the pressing member 104 is moved toward the positive side in the Y-axis direction with the pressing member 104 pressing the film 50 to the adherent 70 between the first retaining portion 111 and the second retaining portion 112. Further, in this step, with the guide member 2 curved in accordance with the shape of the curved surface 70a of the adherent 70, the pressing member 104 can also move in the Y-axis direction while drawing a trajectory in conformance with the shape of the adherent 70. As a result, even when the adherent 70 has a curved shape, the pressing member 104 can be disposed in a position that reaches the adherent 70 in accordance with the curved shape. When the adhering step is completed, the film 50 is cut at the cut line 57, and the adhering jig 100 is removed from the adherent 70. With the above, the adhering method of the film is completed.

Next, the action and advantages of the adhering jig 100 and the adhering method according to the present embodiment will be described.

The film retaining portion 103 can retain the film 50 in the first retaining portion 111 and the second retaining portion 112 separated from each other. Thus, positioned between the adherent 70 and the film 50, the film retaining portion 103 is capable of retaining the film 50. The guide member 102 can guide the movement of the pressing member 104 in the Y-axis direction between the first retaining portion 111 and the second retaining portion 112 of the film retaining portion 103. Thus, the pressing member 104 presses the film 50 retained by the first retaining portion 111 and second retaining portion 112 in the positioned state onto the adherent 70 and, in this state, moves while guided by the guide member 102, making it possible to accurately adhere the film 50 to the adherent 70 in conformance with the guide member 102. With the simple operation of merely retaining the film 50 by the film retaining portion 103 and moving the pressing member 104 in conformance with the guide member 102, the film 50 can be favorably adhered. With the above, it is possible to improve workability when adhering the film 50 to the adherent 70.

In the adhering jig 100, the pressing member 104 may be movable in the X-axis direction. As a result, the pressing member 104 can press the film 50 onto the adherent 70 from the position in which the guide member 102 is slidably attached.

In the adhering jig 100, the film retaining portion 103 may include the pivoting portion 113 that causes the second retaining portion 112 to pivot. As a result, the second retaining portion 112 is pivoted by the pivoting portion 113 once the pressing member 104 moves near the second retaining portion 112, thereby allowing the angle of the film 50 to follow the movement of the pressing member 104.

The adhering jig 100 may further include the attaching portions 106A, 106B that attach the guide member 102 to the adherent 70. In such a configuration, the guide member 102 extends in the Y-axis direction and curves so as to form a projection toward the positive side in the Z-axis direction. As a result, even when the adherent 70 has the curved surface 70a and curves, the guide member 102 can be attached to the adherent 70 so as to correspond to the curved shape. With the guide member 102 curved in accordance with the shape of the curved surface 70a of the adherent 70, the pressing member 104 can also move in the Y-axis direction while drawing a trajectory in conformance with the shape of the adherent 70. As a result, even when the adherent 70 has a curved shape, the pressing member 104 can be disposed in a position that reaches the adherent 70 in accordance with the curved shape. In comparison with the first embodiment described above, while the guide member 2 is pivoted by the pivoting support portion 33 in accordance with the movement of the pressing member 4 in the first embodiment, the guide member 102 and the like do not need to be pivoted while the pressing member 104 is being moved in the Y-axis direction in this configuration, making it possible to easily adhere the film 50.

In the adhering jig 100, the film retaining portion 103 may retain the film 50 so that the film 50 forms a tangent with respect to any position on the curved surface 70a of the adherent 70 between the first retaining portion 111 and the second retaining portion 112, as viewed from the X-axis direction. As a result, it is possible to suppress the occurrence of a portion where the angle of the film 50 in the retained state with respect to the curved surface 70a of the adherent 70 increases excessively in the Y-axis direction. Accordingly, the film 50 can be favorably adhered to the adherent 70.

In the adhering jig 100, the guide member 102 attached to the adherent 70 via the attaching portions 106A, 106B may form a non-parallel positional relationship with the film 50 retained by the film retaining portion 103, as viewed from the X-axis direction. That is, unlike the film 50 that is retained in a straight manner, the guide member 102 may form a shape in conformance with the shape of the curved surface 70a of the adherent 70.

In the adhering jig 100, the attaching portion 106A may connect with the guide member 102 via the pivoting support portion 133 that pivotably supports one end side of the guide member 102 on the negative side in the Y-axis direction. With such a configuration, when the liner 51 is to be peeled from the film 50, the guide member 102 can be pivoted about the pivoting support portion 133, and lifted upward. Thus, the liner 51 can be easily peeled.

The adhering method is an adhering method for adhering the film 50 to the adherent 70 using the adhering jig 100 described above. The method includes the film retaining step of retaining the film 50 by a film retaining portion 103, the attaching step of attaching the guide member 102 to the adherent 70 via the attaching portions 106A, 106B and the adhering step of adhering the film 50 to the adherent 70 by pressing the film 50 retained by the film retaining portion 103 onto the adherent 70 using the pressing member 104 and moving the pressing member 104 in conformance with the guide member 102 attached to the adherent 70. In the attaching step, the guide member 102 may be attached to the adherent 70 so that the guide member 102 curves in conformance with the curved surface 70a of the adherent 70.

Thus, in the adhering step, the guide member 102 is attached to the adherent 70 so as to curve in conformance with the curved surface 70a of the adherent 70, thereby making it possible to attach the guide member 102 to the adherent 70 in accordance with a curved shape when the adherent 70 has the curved surface 70a and curves. With the guide member 102 curved in accordance with the shape of the curved surface 70a of the adherent 70, the pressing member 104 can also move in the Y-axis direction while drawing a trajectory in conformance with the shape of the adherent 70. As a result, even when the adherent 70 has a curved shape, the pressing member 104 can be disposed in a position that reaches the adherent 70 in accordance with the curved shape.

A description of the first embodiment and the second embodiment was given above. Upon comparison, the guide member 2 in the configuration in the first embodiment is pivoted by the pivoting support portion 33 in accordance with the movement of the pressing member 4 and thus does not need to have a curved shape, while the guide member 102 is curved in the second embodiment where a structure for such pivoting is not required. The curvature of this guide member 102 is in conformance with the shape of the adherent 70. Further, the direction of the film 50 retained by the film retaining portion 103 forms a tangent with the adherent 70. Thus, the shape of the guide member 102 roughly forms a tangent with the direction of the film 50 retained by the film retaining portion 103.

Further, because the guide member 102 of the second embodiment corresponds to the shape of the adherent 70 as described above, the shape of the guide member 102 may have to be changed when there is a significant difference from the shape of the adherent 70 (due to shape variation, such as a different vehicle model). In the first embodiment, the configuration is designed so that the guide member 2 pivots by the pivoting support portion 33 while the pressing member 4 is moved, and thus the range of application to differences in shape of the adherent 70 is more extensive than that in the second embodiment.

Further, in the first embodiment, because the guide member 2 pivots and the positional relationship between the guide member 2 and the attaching portions 6A, 6B is variable, the connecting member 34 having a rod shape and connecting the attaching portions 6A, 6B and the lock member 36 are provided. On the other hand, in the second embodiment, because the positional relationship between the guide member 102 and the attaching portions 6A, 6B is basically not variable, members such as the connecting member 34 and the lock member 36 are not needed, achieving a reduction in weight.

The present invention is not intended to be limited to the embodiments described above.

For example, while the second retaining portions 12, 112 each include a pivoting portion in the embodiments described above, the first retaining portions 11, 111 may each include a pivoting portion instead or in addition thereto.

Further, while the guide member 2 is pivoted in accordance with the movement of the pressing member 4 in the first embodiment described above, the guide member 2 may not be pivoted according to the shape of the adherent 70. Further, while the guide member 102 is not pivoted during the movement of the pressing member 4 in the second embodiment, the guide member 102 may be pivoted according to the shape of the adherent 70.

Note that, in the embodiments described above, the body of an automobile is illustrated as an example of the target object for film adherence. However, the target object is not limited to an automobile and other target objects of film adherence may be used as long as the object includes a roof or a side wall. Possible applications include a train, a flight vehicle, a piece of furniture, and an electrical appliance.

### REFERENCE NUMERALS

1, 100 Adhering jig
2, 102 Guide member
3, 103 Film retaining portion
4, 104 Pressing member
6A, 6B Attaching portion (first attaching portion)
106A, 106B Attaching portion (second attaching portion)
11, 111 First retaining portion
12, 112 Second retaining portion
33 Pivoting support portion (first pivoting support portion)
133 Pivoting support portion (second pivoting support portion)
50 Film
70 Adherent

1. An adhering jig for adhering a film to an adherent, comprising:
a film retaining portion that is provided with at least a first retaining portion and a second retaining portion that are separated from each other, and retains the film by the first retaining portion and the second retaining portion;
a pressing member that presses the film retained by the retaining portion to a first side in a first direction; and
a guide member that guides a movement of the pressing member between the first retaining portion and the second retaining portion of the film retaining portion, in a second direction that intersects the first direction.

2. The adhering jig according to claim 1, wherein the pressing member comprises an elastic member capable of expanding and contracting in the first direction.

3. The adhering jig according to claim 1, wherein the film retaining portion further comprises a pivoting portion that causes at least one of the first retaining portion and the second retaining portion to pivot.

4. The adhering jig according to claim 1, further comprising a first attaching portion that attaches the guide member to the adherent, the first attaching portion being connected to the guide member via a first pivoting support portion that pivotably supports one end side of the guide member in the second direction.

5. The adhering jig according to claim 1, further comprising:
a second attaching portion that attaches the guide member to the adherent;
the guide member extending in the second direction and curving so as to form a projection toward a second side in the first direction.

6. The adhering jig according to claim 5, wherein:
the film retaining portion retains the film so that the film forms a tangent with respect to any position on a curved surface of the adherent between the first retaining portion and the second retaining portion, as viewed from a third direction that intersects the first direction and the second direction.

7. The adhering jig according to claim 5, wherein:
the guide member attached to the adherent via the second attaching portion forms a non-parallel positional relationship with the film retained by the film retaining portion, as viewed from the third direction that intersects the first direction and the second direction.

8. The adhering jig according to claim 5, wherein the second attaching portion is connected to the guide member via a second pivoting support portion that pivotably supports one end side of the guide member in the second direction.

9. An adhering method for adhering the film to the adherent using the adhering jig described in claim 4, the method comprising:
a film retaining step of retaining the film by the film retaining portion;
an attaching step of attaching the guide member to the adherent via the first attaching portion; and
an adhering step of adhering the film to the adherent by pressing the film retained by the film retaining portion onto the adherent using a pressing member, and moving the pressing member in conformance with the guide member attached to the adherent;
the film being adhered by the pressing member while the guide member is pivoted by the first pivoting support portion in the adhering step.

10. An adhering method for adhering the film to the adherent using the adhering jig described in claim 5, the method comprising:
a film retaining step of retaining the film by the film retaining portion;
an attaching step of attaching the guide member to the adherent via the second attaching portion; and
an adhering step of adhering the film to the adherent by pressing the film retained by the film retaining portion onto the adherent using the pressing member, and moving the pressing member in conformance with the guide member attached to the adherent;
the guide member being attached to the adherent so as to curve in conformance with a curved surface of the adherent in the attaching step.

11. The adhering jig according to claim 2, wherein the film retaining portion further comprises a pivoting portion that causes at least one of the first retaining portion and the second retaining portion to pivot.

12. The adhering jig according to claim 2, further comprising a first attaching portion that attaches the guide member to the adherent, the first attaching portion being connected to the guide member via a first pivoting support portion that pivotably supports one end side of the guide member in the second direction.

13. The adhering jig according to claim 3, further comprising a first attaching portion that attaches the guide member to the adherent, the first attaching portion being connected to the guide member via a first pivoting support portion that pivotably supports one end side of the guide member in the second direction.

14. The adhering jig according to claim 2, further comprising:
a second attaching portion that attaches the guide member to the adherent;
the guide member extending in the second direction and curving so as to form a projection toward a second side in the first direction.

15. The adhering jig according to claim 3, further comprising:
a second attaching portion that attaches the guide member to the adherent;
the guide member extending in the second direction and curving so as to form a projection toward a second side in the first direction.

16. The adhering jig according to claim 14, wherein:
the film retaining portion retains the film so that the film forms a tangent with respect to any position on a curved surface of the adherent between the first retaining portion and the second retaining portion, as viewed from a third direction that intersects the first direction and the second direction.

17. The adhering jig according to claim 15, wherein:
the film retaining portion retains the film so that the film forms a tangent with respect to any position on a curved surface of the adherent between the first retaining portion and the second retaining portion, as viewed from a third direction that intersects the first direction and the second direction.

18. The adhering jig according to claim 6, wherein:
the guide member attached to the adherent via the second attaching portion forms a non-parallel positional relationship with the film retained by the film retaining portion, as viewed from the third direction that intersects the first direction and the second direction.

19. The adhering jig according to claim 6, wherein the second attaching portion is connected to the guide member via a second pivoting support portion that pivotably supports one end side of the guide member in the second direction.

20. The adhering jig according to claim 7, wherein the second attaching portion is connected to the guide member via a second pivoting support portion that pivotably supports one end side of the guide member in the second direction.
